(19) United States
(12) Patent Application Publication
(10) Pub. No.: US 2010/0322517 A1
(43) Pub. Date: Dec. 23, 2010

(54) IMAGE PROCESSING UNIT AND IMAGE PROCESSING METHOD

(75) Inventor: Kazuhiko Kobayashi, Yokohama-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/797,479

(22) Filed: Jun. 9, 2010

(30) Foreign Application Priority Data
Jun. 18, 2009 (JP) 2009-145822

(51) Int. Cl. G06K 9/34

(52) U.S. Cl. 382/173

(57) ABSTRACT

An image processing unit detects a region that corresponds with a subject from a captured image sequence in which a camera and the subject move, based on the three-dimensional shape and motion of the subject. Regions included in captured images are extracted, correspondence is established between the extracted regions, the shape of the corresponding region is estimated by using three-dimensional positions of feature points in the corresponding region, rigid motion of the corresponding region is estimated by calculating motion of each feature point, and region integration or separation is performed based on the estimated rigid motion, whereby the amount of image feature miscorrespondence can be reduced.

### BACKGROUND OF THE INVENTION

1. Field of the Invention

The present invention relates to an image processing unit and an image processing method for detecting a region, included in a captured image sequence, that includes a moving subject.

2. Description of the Related Art

When a subject to be captured is sufficiently small in size as compared to the distance from an image sensing device to the subject to be captured, or when the amount of movement of the image sensing device (hereinafter referred to as a “camera”) is sufficiently smaller than the distance to the subject to be captured, the observed subject can be viewed as an almost flat plane. In other words, when the variation resulting from the movement of the image sensing device is small with respect to the spatial spread of the subject, a plurality of projection approximations can be used with the proviso that the variation in the observed subject is small. Projection approximation includes weak perspective projection and paraperspective projection that linearly approximate perspective projection, and parallel projection.

According to the publication entitled “Factorization without Factorization: Multibody Segmentation”, Kenichi Kanatani, Technical Report of Institute of Electronics, Information and Communication Engineers, PRMU 98-26, pp. 1-8, 1998, (hereinafter referred to as “Non-Patent Document 1”), in projection approximation, the three-dimensional positions of feature points in images can be represented by linearizing perspective projection calculations. Here, a stationary camera coordinate system is regarded as the world coordinate system, the XY plane is defined as an image plane, and the Z axis is defined as the optical axis of the camera. A position r_{κα} of a feature point p_{α} at time κ can be written as the following Equation (1):

r_{κα}=t_{κ}=a_{α}i_{κ}+b_{α}j_{κ}+c_{α}k_{κ}, (1)

where an object coordinate system is arbitrarily fixed to an object, the coordinates of an αth feature point p_{α} in the object coordinate system are (a_{α}, b_{α}, c_{α}), and the position vector of the origin and the coordinate basis vectors of the object coordinate system at time κ are respectively defined as t_{κ} and {i_{κ}, j_{κ}, k_{κ}}.

If parallel projection, which is an approximation of perspective projection, is assumed, the image coordinates of a point r=(X, Y, Z)^{T} will be (X,Y). The projections of the vectors t_{κ} and {i_{κ}, j_{κ}, k_{κ}}, or in other words, two-dimensional vectors excluding the Z axis coordinates are defined as t′_{κ} and {i′_{κ}, j′_{κ}, k′_{κ}}. When 2M dimensional vectors arranged vertically over K=1, . . . , M are defined as m₀, m₁, m₂, m₃, the 2M dimensional vector p_{α}, defined by Equation (1) can be written as Equation (2):

p_{α}=m₀+a_{α}m₁+b_{α}m₂+c_{α}m₃. (2)

The movement locus of each feature point can be expressed as a single point in 2M dimensional space, and N points p_{α} will be included in the four-dimensional subspace spanned by {m₀, m₁, m₂, m₃}.

Separation of multiple objects involves dividing a set of points in 2M dimensional space into different four-dimensional subspaces.

The publication entitled “A multi-body factorization method for motion analysis”, J. Costeria and T. Kanade, Proc. 5^{th} Int. Conf. Computer Vision (ICCV95), pp. 1071-1076, 1995 (hereinafter referred to as “Non-Patent Document 2”) discloses a method for separating 2M dimensional space as described above by using factorization.

On the other hand, the separation of multiple objects is also possible by using the two-dimensional distribution of feature points in screen coordinates. The publication entitled “Occlusion Robust Tracking Using Constrained Graph Cuts”, Ambai, Ozawa, Journal A of Institute of Electronics, Information and Communication Engineers, Vol. J90-A, No. 12 pp. 948-959, 2007 (hereinafter referred to as “Non-Patent Document 3”) discloses a method for tracking vehicles traveling on a roadway in which a vehicle is tracked by clustering a locus group of feature points with graph-cut algorithm. The method disclosed involves formulating the separation of multiple objects as a graph cut problem by representing a group of feature points on a screen as a graph and using tracking information of past frames as constraint conditions.

Furthermore, rather than using geometric features, a segmentation technique that detects a region by using pixel color information can also be used to separate an object region on a screen. The publication entitled “Interactive Graph Cuts for Optimal Boundary & Region Segmentation of Objects in N-D Images”, Y. Boykov, M. Jolly, Proc. of International Conference of Computer Vision, vol. I, pp. 105-112, 2001 (hereinafter referred to as “Non-Patent Document 4”) discloses a technique, called “graph-cutting”, regarding segmentation of images into objects and background. The relationship between a set of pixels and a set of neighboring pixels is expressed as a graph, and a cost representing which graph node an edge pixel belongs to is calculated to determine which region the pixel belongs to.

The techniques described in Non-Patent Documents 1 and 2 work successfully in a range where the projection of feature points can be approximated by parallel projection, with the proviso that the relationship between camera and subject does not change significantly between the previous and subsequent images in a captured image sequence. However, “appearance” that cannot be approximated by parallel projection does, in fact, occur in the representation of feature points belonging to a subject observed from an image. In other words, differences or occlusion of “appearance” can occur due to the size of the subject and the position of the camera, or the relative motion between a plurality of subjects and the camera. Particularly when the camera is turned right around while shooting or when the subject is rotating, the possibility of failing to track feature points increases. In addition, because errors in three-dimensional estimation by projection approximation exert a large influence, the accuracy of object shape estimation decreases when the focal length of the camera and the distance to the subject are close.

With the method of Non-Patent Document 3 that determines variations of two-dimensional regions without using projection transformation, it is difficult to appropriately separate a plurality of subjects when the subjects move independently after regions have overlapped. Because this method does not give consideration to three-dimensional motion of regions, even when the regions have different depths, they appear the same in terms of screen coordinates, so the regions end up being determined as the same region in the case where occlusion has occurred.

Non-Patent Document 4 requires that color attributes of background regions and foreground regions are instructed as prior knowledge, and, like Non-Patent Document 3, does not give consideration to the three-dimensional motion of subjects, so it is difficult to separate the regions when they are mixed together.

As described above, establishing correspondence between regions is difficult by using the conventional techniques when the spatial spread of a subject in the depth direction is large with respect to the amount of movement of the camera, particularly when the distance between the camera and the subject space is small. This occurs when shooting with an ordinary video camera, that is, when the cameraman captures people or objects in front of the cameraman while holding the camera by hand. Establishing correspondence between regions from a captured image sequence cannot be performed successfully with the methods of Non-Patent Documents 1 and 2, with respect to the motion of a subject that cannot be approximated by parallel projection.

### SUMMARY OF THE INVENTION

In light of the background, the present invention solves the above-described problems by establishing correspondence between regions while estimating three-dimensional motions of the regions, taking the spatial three-dimensional position of the subject into consideration. Accordingly, in view of the above problems, the present invention provides an image processing unit that detects a region that is in correspondence with a subject based on the three-dimensional shape and motion of the subject from a captured image sequence in which a camera and the subject are moving.

The present invention can solve the problems encountered with conventional technology by using an image processing unit that detects a subject region from a captured image sequence, the image processing unit including: an image acquisition unit configured to receive a plurality of captured images; a region extraction unit configured to extract a plurality of regions from each of the plurality of captured images according to an attribute of each pixel; a region correspondence unit configured to determine corresponding regions between the plurality of captured images, according to an attribute of each of the plurality of regions extracted by the region extraction unit; a region shape estimation unit configured to estimate a shape of the corresponding region by estimating three-dimensional positions of feature points within an image of the corresponding region; a region rigid motion estimation unit configured to estimate rigid motion of the corresponding region by calculating motion of each feature point of the corresponding region based on the three-dimensional position thereof; and a region change unit configured to integrate more than one regions of the plurality of regions when an accuracy of rigid motion estimated assuming that the more than one regions are integrated is determined to be higher than the rigid motion estimated for each of the more than one regions.

Further features of the present invention will become apparent from the following description of exemplary embodiments with reference to the attached drawings.

### BRIEF DESCRIPTION OF THE DRAWINGS

FIG. 1 is a diagram showing a configuration of primary components of an image processing unit according to Embodiment 1.

FIG. 2 is a diagram showing a configuration in which the image processing unit according to Embodiment 1 is used.

FIG. 3 is a diagram showing a configuration of primary components of an image processing unit according to Embodiment 2.

FIG. 4 is a flowchart illustrating a processing procedure of an integration/separation control section according to Embodiment 2.

FIG. 5 is a diagram showing a configuration in which data of a subject is shared by using a program that implements an image processing method according to another embodiment of the present invention.

### DESCRIPTION OF THE EMBODIMENTS

The following description discloses exemplary embodiments of the present invention.

### Embodiment 1

Embodiment 1 of the present invention will be described first.

Configuration

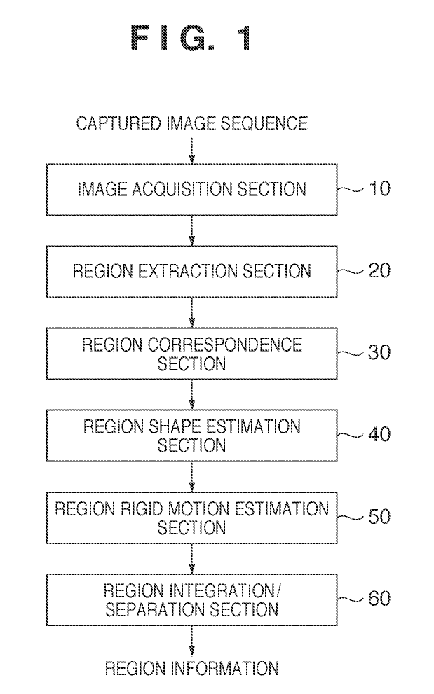

FIG. 1 shows an example of a configuration of primary components of an image processing unit as an image processing unit according to Embodiment 1. As shown in FIG. 1, the image processing unit includes an image acquisition section 10, a region extraction section 20, a region correspondence section 30, a region shape estimation section 40, a region rigid motion estimation section 50 and a region integration/separation section 60.

The image acquisition section 10 obtains image data by writing two or more images acquired by, for example, an image sensing device into a memory. The region extraction section 20 extracts regions from the acquired images based on attributes. The region correspondence section 30 establishes correspondence for each of the extracted regions, and the region shape estimation section 40 estimates the shape of the regions by using the result thereof. The region rigid motion estimation section 50 estimates the rigid motion of the regions by using a plurality of results of shape estimation performed by the region shape estimation section 40. The region integration/separation section 60 integrates or separates the plurality of regions by using the result of rigid motion estimated by the region rigid motion estimation section 50. It is therefore possible to detect a region that is in correspondence with a subject from captured images and estimate the position and posture of the subject.

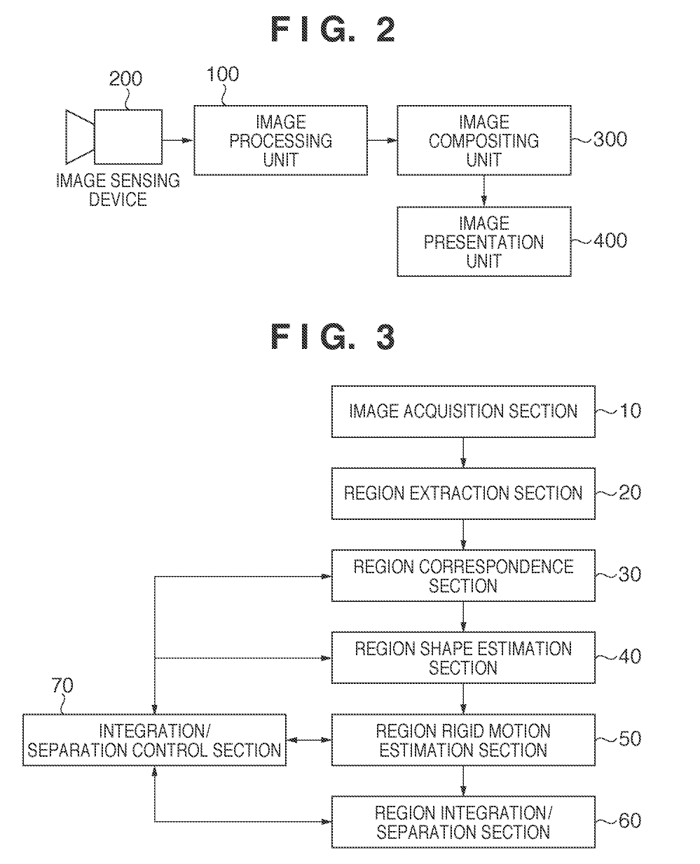

FIG. 2 shows a configuration of other primary functions that are connected to the image processing unit of Embodiment 1. The image processing unit of the present invention can be implemented as an image processing unit 100 as shown in FIG. 2. The image processing unit 100 receives input of images of a subject captured by an image sensing device 200. In the image processing unit 100, region information is generated from the image information. Furthermore, the image processing unit 100 is connected to an image compositing unit 300 that composites images by using the region information. The composited images generated by the image compositing unit 300 can be viewed on an image presentation unit 400. The image sensing device 200, the image compositing unit 300 and the image presentation unit 400 are used as an example of the present embodiment of the invention, and are not intended to limit the signal formats and the mechanisms relating to input and output of the image processing unit.

For example, as the image sensing device 200, a device that includes a semiconductor element that is an electro-optical converter element such as a CCD or CMOS can be used. Generally, optical distortions are present in a lens constituting an image sensing device, but they can be subjected to camera calibration by using calibration patterns to acquire correction values in advance. It is generally possible to use image sequences captured with a video camera or the like and extracted from moving image files recorded in an arbitrary medium. It is also possible for image sequences that are currently being captured to be received and used via a network.

As an example of the image compositing unit 300, a personal computer that includes an image input interface board can be used because it is sufficient that computer graphics can be composited by using image signals. In addition, instead of the image compositing unit, it is also possible for the regions of a moving object are stored in a recording device and used as information regarding the captured images.

In the configuration shown in FIG. 2, the units are configured as separate devices, but they may be connected with input/output cables. They may exchange information via a bus formed on a print substrate. For example, a device with a capturing function and an image presentation function that displays images, such as a digital camera, may have the functions of the image processing unit of the present invention.

Image Acquisition Section

The image acquisition section 10 will be described first. As captured images including a subject, the image acquisition section 10 acquires, for example, two-dimensional images such as color images. A color image is made up of units called pixels, and the pixels store, for example, RGB color information. A color image is realized by arranging these pixels in a two-dimensional array of rows and columns. For example, a VGA (Video Graphics Array) size color image is expressed by a two-dimensional array of 640 pixels in the x axis (horizontal) direction and 480 pixels in the y axis (vertical) direction, and each pixel stores color information at the position of the pixel in, for example, RGB format. When a monochrome image is used instead of a color image, the monochrome image pixel value is a density value that represents the amount of light to each image sensing element.

The image acquisition section 10 can be any kind as long as it can acquire images including a subject from an image sensing device, and the size of the pixel array, the color arrangement or number of gray levels, and the camera parameters of the image sensing device are in fact assumed to be known values.

Region Detection Section

The region detection section 20 performs a process that extracts regions from captured images obtained by the image acquisition section 10. “Region extraction” as used herein means to detect small regions that have common two-dimensional image attributes. At this time, whether the regions are part of a moving subject or part of the background is unknown. As pixel attributes, color and density gradient can be used. The attributes may depend on the color, pattern and the like of a subject, so region detection can be performed by using a plurality of attributes.

For example, to detect regions of a similar color, RGB color information, which is the color of pixels, is converted to an HSV color system, and by using the hue information obtained as a result, adjacent regions that have the same color can be detected. This can be accomplished by an image process generally called “color labeling”. It is also possible to use texture information. By using image feature amounts or density gradient values for extracting the periodicity or directionality of local regions of the density distribution, regions of the same pattern can be detected.

Furthermore, by using region detection by graph cutting disclosed in Non-Patent Document 4, regions that have a plurality of color attributes can be detected as a single region. Here, it is only necessary to detect a range of adjacent pixels that have similar attributes for region detection. Accordingly, existing region detection can be used.

Region Correspondence Section

The region correspondence section 30 determines region correspondence for the pixel regions detected by the region detection section 20 from captured images by using image feature amounts. In the vicinity of the boundary of the regions detected by the region detection section 20, constantly stable detection is not possible due to insufficient lighting and the influence of occlusions by another object. Accordingly, a region with characteristic density gradient is extracted from each of the regions detected by the region detection section 20.

For example, as an image feature amount, whether the pixel density gradient of a local region has the shape of a corner can be used. For example, by using the Harris operator, the density gradient of a region surrounding a pixel of interest is calculated, and the curvature of the density gradient is calculated using Hessian matrix values, and thereby the image feature amount of a region that has a corner or edge feature can be calculated. It is also possible to calculate the image feature amount of an edge component by using a Sobel filter or Canny filter that detects an outline or line segment as a density gradient in an image, a Gabor feature amount or the like. Here, image feature amount calculation methods used in the field of image processing can be used.

As stated in Non-Patent Documents 1 and 2, they are based on the proviso that when the distance between subject and image sensing device is sufficiently large, and the movement of the subject approximates parallel movement, the variation in the feature amount detected as an image feature is small before and after a captured image sequence.

However, generally, when shooting by hand, there are no constraints on the relationship between subject and image sensing device and the movement of the subject, and therefore it is difficult to accurately calculate an image feature amount by comparing image feature amounts detected as described above. Accordingly, initial region correspondence is determined by using a plurality of image feature amounts.

The screen coordinates of the α-th feature point P_{φκα} belonging to the φ-th region L at time κ are defined as X_{φκα}={X_{φκα}, Y_{φκα}}. When the density in a coordinate vector X of captured images is expressed by I(X), the density value of each pixel in the local image at the feature point can be expressed by I(X_{φκα}+Δs), where Δs indicates a range of the local image, and Δs={sx, sy}, where sx represents a relative position in the X axis direction of the feature point, and sy represents a relative position in the Y axis direction. If the captured image is a color image, the density I of the local image includes red, green and blue elements, and I(X_{φκα}+Δs)={I (X_{φκα}+Δs)ᵣ, I(X_{φκα}+Δs)_{g}, I(X_{φκα}+Δs)_{b}} is obtained. If it is assumed that N feature points have been detected in the region L, then α=1, . . . , N is obtained. The range Δs of the local image is defined to range from −S to S, and the average of the color information included in the φ-th region L is calculated. The average L_{φκr} of the red component is written as Equation (3):

$${L}_{φκ r} = \frac{1}{4 {S}^{2} N} {\sum }_{a = 1}^{N} {\sum }_{s x = - S}^{S} {\sum }_{s y = - S}^{S} {I ( {X}_{φκα} + Δ s )}_{r} , \qquad ( 3 )$$

the average L_{φκg} of the green component is written as Equation (4):

$${L}_{φκ g} = \frac{1}{4 {S}^{2} N} {\sum }_{a = 1}^{N} {\sum }_{s x = - S}^{S} {\sum }_{s y = - S}^{S} {I ( {X}_{φκα} + Δ s )}_{g} , \qquad ( 4 )$$

and the average L_{φκb} of the blue component is written as Equation (5):

$${L}_{φκ b} = \frac{1}{4 {S}^{2} N} {\sum }_{a = 1}^{N} {\sum }_{s x = - S}^{S} {\sum }_{s y = - S}^{S} {I ( {X}_{φκα} + Δ s )}_{b} . \qquad ( 5 )$$

A color information vector L_{φκ}={L_{φκr}, L_{φκg}, L_{φκb}} of the φ-th region L at time κ is composed of three elements. Assuming that color constancy is maintained in the captured image sequence, region correspondence between frames can be obtained by selecting regions with similar color information vector distances as correspondence candidates. The difference DL between the color information vector of the φ-th region at time κ and the color information vector of the φ′-th region at time κ′ is written as Equation (6) with the use of the symbol indicating the vector norm ∥∥:

DL_{kφ}(κ′,φ′)=∥L_{φκ}−L_{φ′κ′}∥. (6)

The color information vector difference DL is calculated, and correspondence candidates can be selected in ascending order of the value. A plurality of candidates are preferably selected because when there are color variations due to lighting, the corresponding range can be widened and checked. Here, correspondence of the α-th feature point P_{φακ} of the φ-th region at time κ and correspondence of the α′-th point P_{φ′α′κ′} of the φ′-th region at time κ′ are determined by using the color information vectors. With a simple pixel comparison, when the camera or subject moves almost parallel to the image plane, the density difference G(φακ, φ′α′κ′) between two local images can be written as Equation (7):

$$G ( φακ , {φ}^{′} {α}^{′} {κ}^{′} ) = \frac{1}{4 {S}^{2}} {\sum }_{s x = - S}^{S} {\sum }_{s y = - S}^{S} \vert \begin{matrix}I ( {X}_{φακ} + Δ s ) - \\ {I}^{′} ( {X}_{{φ}^{′} {α}^{′} {κ}^{′}} + Δ s )\end{matrix} \vert , \qquad ( 7 )$$

where |x| is an absolute value of x.

When initial region correspondence candidates are determined, of the two images, α′ at which the density difference G is the smallest serves as correspondence of the feature point. Equation (7) is effective when the spatial spread of the subject observed by the camera varies little as in Non-Patent Documents 1 and 2. However, as discussed in the above Description of the Related Art section, when the subject is rotating or the like, correspondence that satisfies the conditions may not be obtained sufficiently.

Accordingly, in the present embodiment, the region correspondence section 30 establishes correspondence of a local image region by using the result of rigid motion estimation of the region. Here, a rigid motion estimated from the past images in consideration of temporal succession is used.

Specifically, for an image at time κ, the results of rigid motion estimation at time κ−1, κ−2, . . . , 1 are used. The rigid motions are estimated by the region rigid motion estimation section 50, which will be described later. As an initial value at time κ=0, the subject may be regarded as stationary, or a random number or constant within the scope of the assumption may be given as rigid motion.

Next, region correspondence establishment at time κ is considered. Here, it is assumed that, at time κ−n, rigid motion values estimated by the region rigid motion estimation section 50 have been acquired, but by processing images in time-series, the previous estimation results can be used.

According to the publication entitled “Fundamentals of Robot Vision”, Koichiro Deguchi, Corona Publishing Co., Ltd., June, 2000, camera motion can be reconstructed from the movement of feature points of images in an image sequence.

At time κ−n, positions x_{1κ-1}, . . . , x_{NκK-n} of N points p_{1κ-1}, . . . , p_{Nκ-n} whose three-dimensional position in the camera coordinate system is known are used. When the camera shows a parallel movement V_{κ-n} and a rotational movement Ω_{κ-n}, the speed Δp_{iκ-n} in the camera coordinate system of each point p_{iκ-n} in the camera coordinate system is written as Equation (8):

Δp_{iκ-n}=−V_{κ-n}−Ω_{κ-n}×x_{iκ-n}, (8)

where the subscript “i” is 1 to N.

The relationship between the position x_{iκ-1} of the point pᵢ before the movement of the camera and the position x_{iκ} after the movement of the camera is x_{iκ}=x_{iκ-n}+Δp_{iκ-n}, and therefore can be written as Equation (9):

x_{iκ}=F_{κ-n}x_{iκ-n}−V_{κ-n}, (9)

where F_{κ-n} can be represented as a matrix written as Equation (10):

$${F}_{κ - n} = [ \begin{matrix}1 & {Ω}_{z κ - n} & - {Ω}_{y κ - n} \\ - {Ω}_{z κ - n} & 1 & {Ω}_{x κ - n} \\ {Ω}_{y κ - n} & - {Ω}_{x κ - n} & 1\end{matrix} ] . \qquad ( 10 )$$

In addition, projection points P_{iκ-n}=X_{iκ-n} and P_{iκ}=X_{iκ} on the image of the points p_{iκ-n} and p_{iκ} can be obtained from an equation of perspective projection and written as Equation (11):

$${X}_{i κ} = ( \begin{matrix}f \frac{{x}_{i κ}}{{z}_{i κ}} \\ f \frac{{y}_{i κ}}{{z}_{i κ}}\end{matrix} ) , \qquad ( 11 )$$

where f denotes the focal length.

The position X_{iκ} of the projection point P_{ik at time κ is calculated from the parallel movement component V}_{κ-n} and the rotational motion component Ω_{κ-n} serving as motion parameters at time κ−n, and the point P_{iκ-n} in the camera coordinate system. Specifically, Equation (9) is substituted into Equation (11) to obtain Equation (12):

$${X}_{i κ} = ( \begin{matrix}f \frac{{x}_{i κ - n} + {Ω}_{z κ - n} {y}_{i κ - n} - {Ω}_{y κ - n} {z}_{i κ - n} - {V}_{x κ - n}}{{Ω}_{y κ - n} {x}_{i κ - n} - {Ω}_{x κ - n} {y}_{i κ - n} + {z}_{i κ - n} - {V}_{z κ - n}} \\ f \frac{- {Ω}_{z κ - n} {x}_{i κ - n} + {y}_{i κ - n} + {Ω}_{x κ - n} {z}_{i κ - n} - {V}_{x κ - n}}{{Ω}_{y κ - n} {x}_{i κ - n} - {Ω}_{x κ - n} {y}_{i κ - n} + {z}_{i κ - n} - {V}_{z κ - n}}\end{matrix} ) . \qquad ( 12 )$$

Equation (12) is an equation for estimating a position in a captured image by using motion parameters of points whose three-dimensional position is known. Because, actually, none of the three-dimensional positions and motion parameters of feature points are initially known, it is not possible to use Equation (12) without knowing these. It is, however, possible to use estimated values obtained as a result of shape estimation and motion estimation, which will be described later.

For the feature point P_{φακ}, which is the image coordinates of the α-th feature p_{φακ} in the φ-th region at time κ, by using an estimated three-dimensional position x_{φακ}={x_{φακ}, y_{φακ}, z_{φακ}} in the camera coordinate system and motion parameters V_{φκ}={V_{xφκ}, V_{yφκ}, V_{zφκ}} and Ω_{φκ}={Ω_{xφκ}, Ω_{yφκ}, Ω_{zφκ}}, an estimated position J can be determined by the following Equation (13):

$$J ( φ , α , κ ) = ( \begin{matrix}f \frac{{X}_{φακ} / {z}_{φακ} + {Ω}_{z φκ} {Y}_{φακ} / {z}_{φακ} - {Ω}_{y φκ} {z}_{φακ} - {V}_{x φκ}}{{Ω}_{y φκ} ( {X}_{φακ} / {z}_{φακ} ) - {Ω}_{x φκ} ( {Y}_{φακ} / {z}_{φακ} ) + {z}_{φακ} - {V}_{z φκ}} \\ f \frac{- {Ω}_{z φκ} ( {X}_{φακ} / {z}_{φακ} ) + ( {Y}_{φακ} / {z}_{φακ} ) + {Ω}_{y φκ} {z}_{φακ} - {V}_{x φκ}}{{Ω}_{φκ} ( {X}_{φακ} / {z}_{φακ} ) - {Ω}_{x φκ} ( {Y}_{φακ} / {z}_{φακ} ) + {z}_{φακ} - {V}_{z φκ}}\end{matrix} ) . \qquad ( 13 )$$

When the estimated position J of Equation (13) is substituted into X_{φακ} of Equation (7), the density difference G′ considering motion and three-dimensional position can be written as the following Equation (14):

$${G}^{′} ( φακ , {φ}^{′} {α}^{′} {κ}^{′} ) = \frac{1}{4 {S}^{2}} {\sum }_{s x = - S}^{S} {\sum }_{s y = - S}^{S} \vert \begin{matrix}I ( J ( φ , α , κ - n ) + Δ s ) - \\ {I}^{′} ( {X}_{{φ}^{′} {κ}^{′} {α}^{′}} + Δ s )\end{matrix} \vert . \qquad ( 14 )$$

The density difference G′ of Equation (14) calculates the corresponding density value by using screen coordinates estimated from the motion parameters at time κ-n, and since the stationary motion parameter values are 0, it is the same as Equation (7). Equation (14) may be calculated assuming that, in local image I, the depth value of an adjacent pixel is the same as that of the pixel of interest, or if the position has already been determined through region shape estimation, which will be described later, it may be used.

Region Shape Estimation Section

The region shape estimation section 40 determines three-dimensional coordinates of feature points within an image of a region. Shape estimation in the camera coordinate system involves estimating a depth value z of a feature point.

An optical flow of the i-th feature point whose correspondence was established at time κ can be written as Equation (15):

\dot{X}_{iκ}=(X_{iκ}−X_{iκ-1},Y_{iκ}−Y_{iκ-1}). (15)

Furthermore, by using motion parameters V_{κ-1} and Ω_{κ-1} of the image sensing device estimated at time κ−1, a depth at time κ−1 expressed by Equation (16) is obtained from Equations (9) and (11):

$${z}_{i κ - 1} = \frac{f {X}_{i κ} {V}_{x κ - 1} - {f}^{2} {V}_{x κ - 1}}{{X}_{i κ} ( \begin{matrix}f - {Ω}_{x κ - 1} {Y}_{x κ - 1} + \\ {Ω}_{y κ - 1} {X}_{i κ - 1}\end{matrix} ) - f {X}_{i κ - 1} - {Ω}_{z κ - 1} f {Y}_{i κ - 1} + {Ω}_{y κ - 1} {f}^{2}} , \qquad ( 16 )$$

where f is the focal length of the camera.

Initially, motion parameters have not been estimated, and therefore a process by the region rigid motion estimation section 50, which will be described later, may be executed in advance.

Region Rigid Motion Estimation Section

If perspective projection is assumed, the three-dimensional position p_{iκ} in the camera coordinate system and coordinates in the captured image have a relationship represented by Equation (11). The motion parameters of the camera are organized by substituting Equation (9) into Equation (11) to eliminate x_{iκ}, y_{iκ} and z_{iκ}.

As equations representing the three-dimensional coordinates of the point p_{iκ} in the camera coordinate system at time κ−n, the parallel motion component V_{κ-n}, the rotational motion component Ω_{κ-n} of the camera, and the estimated depth value zᵢₖ, and the relationship between the coordinates X_{iκ} of the feature point P_{iκ} and the coordinates X_{iκ-n} of P_{iκ-n} on the image screen, Equations (17) and (18) are obtained:

−X_{iκ}y_{iκ-n}Ω_{xκ-n}+(X_{iκ}x_{iκ-n}+fz_{iκ-n})Ω_{yκ-n}−fy_{iκ-n}Ω_{zκ-n}+fV_{xκ-n}−X_{iκ}V_{zκ-n}=fx_{iκ-n}−X_{iκ}z_{iκ-n} (17)

and

(−Y_{iκ}y_{iκ-n}−fz_{iκ-n})Ω_{xκ-n}+Y_{iκ}x_{iκ-n}Ω_{yκ-n}+fx_{i-κ}Ω_{zκ-n}+fV_{yκ-n}−Y_{iκ}V_{zκ-n}=fy_{iκ-n}−Y_{iκ}z_{iκ-n} (18).

Because two equations: Equations (17) and (18) are obtained for known M points, 2M equations are obtained in total. The 2M equations are simultaneous equations with six unknowns in total because motion parameters V and Q are each composed of three elements. Accordingly, optical flow vectors corresponding to at least three points are necessary to calculate V and Q. When there are more than three points, a least-squares method can be used for the calculation.

When the position of points is unknown, it can also be estimated as an unknown variable. Accordingly, calculation is performed by treating the three-dimensional positions of feature points and five motion parameters obtained by excluding scale motion components as unknowns. In other words, as equations for solving 3M+5 unknowns, Equations (17) and (18) are obtained for each point, so they can be determined by solving simultaneous equations composed of the correspondences of five points.

The region shape estimation section 40 randomly samples five points from the feature points in the corresponding regions determined by the region extraction section 20, and calculates simultaneous equations defined by Equations (17) and (18). Then, the three-dimensional position of the feature points and the motion parameters of the regions are estimated.

However, sampling only once may produce estimation results with a large error due to miscorrespondence of regions, and therefore by performing sampling a plurality of times and selecting those with a small error therefrom, the influence of miscorrespondence can be reduced.

### Region Integration/Separation Section

In an actual image, a large number of small regions may be detected by the region detection section 20. Although the processes of the region shape estimation section 40 and the region rigid motion estimation section 50 can be performed on each region, when the amount of area tracked is small with respect to a screen, it is easily affected by error. Accordingly, when a plurality of regions can be approximated as a single rigid motion, an integration process is performed to improve estimation accuracy. When another rigid motion object is included in a region, the estimation accuracy decreases, and therefore the region is detected and separated.

It is assumed here that a region A and a region B are moving with the same rigid motion at time κ−1. Then, the parallel movement component V_{Aκ-1} of the region A and the parallel movement component V_{Bκ-1} of the region B have the same value, and the rotational motion components Ω_{Aκ-1} and Ω_{Bκ-1} are also the same. However, it is rare that they have exactly the same values due to the influence of feature point detection errors and calculation errors. Accordingly, when the rigid motions of the regions that are moving with an almost similar motion are integrated into a single rigid motion, the amount of area of the region tracked increases, so errors can be relatively reduced. Conversely, when part of a region moves differently, errors are relatively increased as compared to before it started to move differently. In other words, by observing the relative variation of error, whether to ingrate or separate regions can be determined.

The region integration/separation section 60 performs a process for integrating the rigid motions of a plurality of regions and a process for separating the same. First, a process for integrating regions that are moving with the same rigid motion will be described.

It is assumed here that A-th region and the B-th region are obtained from the regions detected from the same time image, and the motion parameter difference between the A-th region and the B-th region is D(A,B). By using the squares of the norms of respective vectors of the parallel movement components and the rotational motion components, D(A,B) can be written as Equation (19):

D(A,B)=∥V_{A}−V_{B}∥²+∥Ω_{A}−Ω_{B}∥² (19)

For the A-th region, the motion parameter difference D with a region other than the A-th region detected from the screen is calculated, and the calculated values are sorted in ascending order of the calculated values. Candidates that show a motion similar to the motion parameter A can be thereby selected. As the order of region selection for the A-th region, when selection is made sequentially in descending order of the size (area) of each region on the screen, the estimation accuracy is improved because the influence of errors is reduced.

By using Equation (12), screen coordinates at time κ can be estimated from motion parameters at time κ−n and a three-dimensional position in the camera coordinate system. Accordingly, by using a feature point p_{iκ-n} of the region A at time κ−n and the motion parameters V_{κ-n} and Ω_{κ-n} at that time, screen coordinates estimated at time κ are obtained as X′_{iκ}(A). When the difference with screen coordinates X_{iκ}(A) of a feature point P_{iκ} of the region A detected from the captured image at time κ is defined as projection plane error E_{iκ}, it can be written as the following Equation (20):

E_{Aiκ}=|X_{iκ}(A)−X′_{iκ}(A)| (20)

It is assumed that a set of n feature points randomly sampled from the feature points of the region A is defined as C_{nA}. Then, the sum of projection screen errors of the set C_{nA} defined as ΣE_{Aκ}(n) is calculated by Equation (21):

$$\sum {E}_{A κ} ( n ) = \sum {E}_{A i κ} = {\sum }_{i ∈ {C}_{n A}} \vert {X}_{i κ} ( A ) - {X}_{i κ}^{′} ( A ) \vert . \qquad ( 21 )$$

Similarly, the sum of projection screen errors in the region B defined as ΣE_{Bκ}(n) can be written as Equation (22):

$$\sum {E}_{B κ} ( n ) = {\sum }_{i ∈ {C}_{n B}} \vert {X}_{i κ} ( B ) - {X}_{i κ}^{′} ( B ) \vert . \qquad ( 22 )$$

Next, the sum of projection screen errors is determined assuming that the region A and the region B have been integrated. To that end, at time κ−n, the region A and the region B are treated as a single region that shows the same rigid motion. In other words, in the motion parameter estimation using Equations (17) and (18), parameter estimation is performed by using a set C_{nA∩B} of n feature points randomly selected from the region A∩B obtained by combining the region A and the region B. The sum of projection screen errors defined as ΣE_{A∩Bκ}(n) can be written as Equation (23):

$$\sum {E}_{A ⋂ B κ} ( n ) = {\sum }_{i ∈ {C}_{n A ⋂ B}} \vert {X}_{i κ} ( A ⋂ B ) - {X}_{i κ}^{′} ( A ⋂ B ) \vert . \qquad ( 23 )$$

In the integration process, if the result of rigid motion estimation of the integrated region of the region A and the region B is higher than the average of estimation result determined for each region, the region A and the region B are integrated for change of region. Higher estimation results mean less projection screen errors, so integration is performed when the following relational Equation (24) is satisfied:

$$\sum {E}_{A ⋂ B κ} ( n ) < \frac{1}{2} ( \sum {E}_{A κ} ( n ) + \sum {E}_{B κ} ( n ) ) , \qquad ( 24 )$$

where n can be 5 or greater, but if n is too large, the possibility that regions of miscorrespondence might be included in the selected feature points increases, and a situation can often occur in which Equation (24) is not satisfied all the time due to the influence of a single error. Accordingly, n is set to 5 to 10, and the processing from Equation (22) to Equation (23) is performed a plurality of times, and the results are sorted to obtain an intermediate value. By using the intermediate value, the influence of miscorrespondence can be reduced.

Next, separation when another motion is included in a region will be described. In the region A that showed the same rigid motion until time κ−1, a local region B of the region A that shows another rigid motion is assumed to be included at time κ. Then, the value of the sum of projection screen errors with motion parameters estimated assuming the same rigid motion increases due to the influence of the local region B. In order to determine whether or not to separate the region, the variation over time of error of the sum of projection screen errors is checked, and Equation (25) is used:

|ΣE_{Aκ}(n)−ΣE_{Aκ-1}(n)|²>econst (25)

where econst is a constant determined empirically, and it is a prescribed level. When Equation (25) is satisfied, and the accuracy of rigid motion estimated for one of a plurality of regions falls below the prescribed level, a region with another rigid motion is determined to be present at time κ, and a separation process is performed.

In the separation process, a portion with another rigid motion included in the region is extracted. A set of feature points included in the region A is registered in set A as inliers. Specifically, when a randomly extracted set C_{nA} does not satisfy Equation (25), it is registered as inliers in C′_{A} as a part of the region A.

On the other hand, when another rigid motion is included in the selected set of feature points, a feature point with another rigid motion serves as an outlier, which causes a large screen projection error. Accordingly, the feature point is extracted, and registered in a set other than the region A. Specifically, when the randomly extracted set C_{nA} satisfies Equation (25), it is determined that an outlier feature point is included in the set.

To select specific outliers, information regarding a single feature point is extracted from C_{nA}, n−1 feature points are selected from the set C′_{A} already registered as the region A, and whether they satisfy Equation (25) is checked. If the feature point extracted from C_{nA} is an outlier, the n−1 feature points are likely to satisfy Equation (25) even when the values of C′_{A} belong to A. This is sequentially repeated for all of the feature points of C_{nA}. The feature points detected as outliers are registered in an outlier set C′_{B}.

When all of the feature points included in the region A have been processed, B of Equation (24) is replaced with C′_{B} by using the outlier set C′_{B}, and a check is performed. If Equation (24) is not satisfied, the outlier set C′_{B} is likely to be another rigid motion, so it is registered as a rigid motion in the subsequent image sequences.

### Embodiment 2

Because the region integration/separation section 60 performs region integration and separation in an exploratory manner in Embodiment 1, improved estimation accuracy can be expected by repeating the process starting with region correspondence establishment. Accordingly, Embodiment 2 of the present invention illustrates an example of an image processing unit that includes an integration/separation control section that performs control to improve estimation accuracy by repeatedly processing estimation results.

FIG. 3 shows an example of a configuration of primary components of an image processing unit that includes an integration/separation control section 70 as an image processing unit according to the present embodiment. The functions of the image acquisition section 10, the region extraction section 20, the region correspondence section 30, the region shape estimation section 40, the region rigid motion estimation section 50 and the region integration/separation section 60 are basically the same as those described in connection to FIG. 1, and therefore a description thereof is omitted here.

The integration/separation control section 70 passes on region estimation results to a processor for respectively implementing the region correspondence section 30, the region shape estimation section 40, the region rigid motion estimation section 50 and the region integration/separation section 60, and performs control using the processing results.

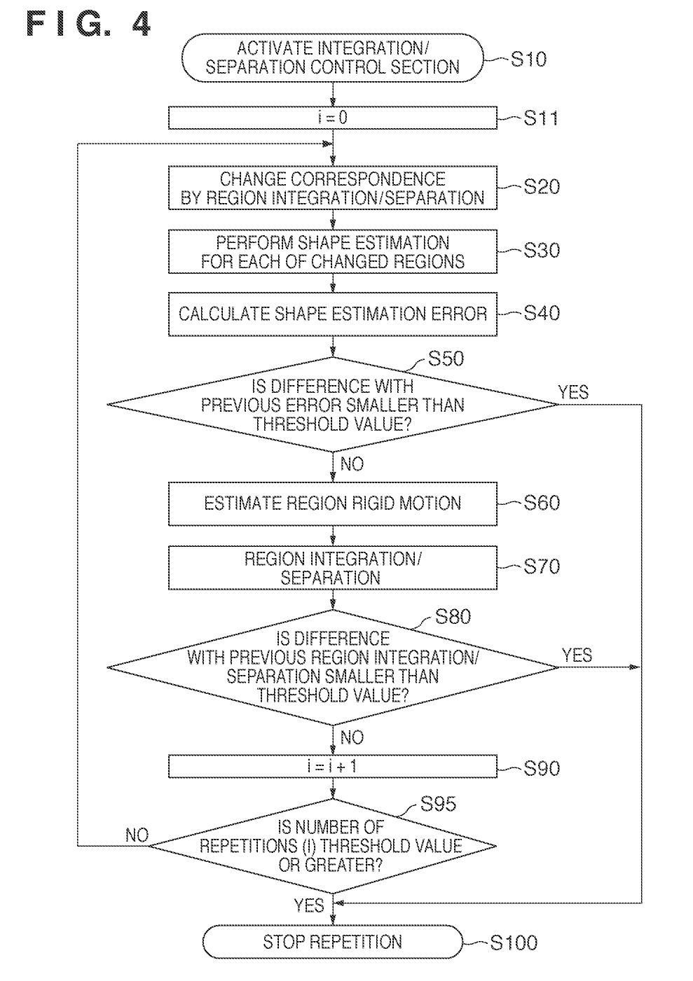

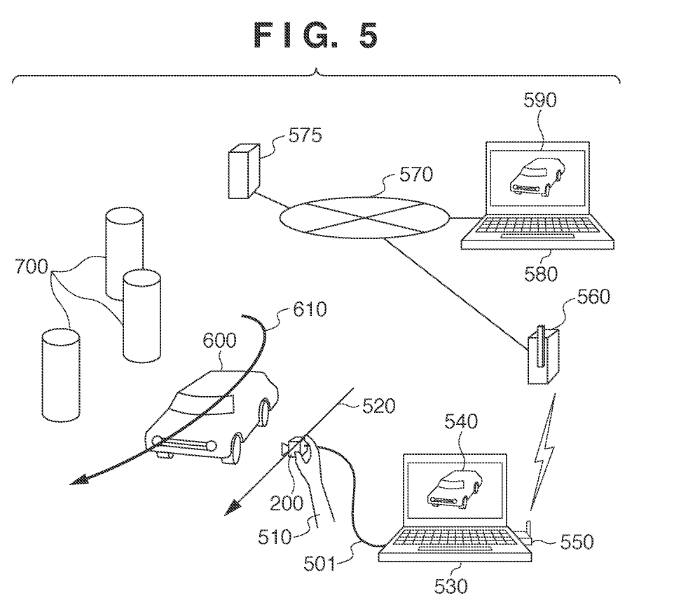

FIG. 4 is a flowchart illustrating primary steps of an internal processing procedure of the integration/separation control section 70. A specific processing procedure will be described with reference to this flowchart. The flowchart illustrates only primary steps of an internal processing procedure of the integration/separation control section, and it actually requires steps of storing data of results of respective processing and the like.

First, the integration/separation control section 70 starts the following step operations when region detection is performed by the image acquisition section 10 and the region extraction section 20.

In Step S10, the integration/separation control section is activated when an output of the region extraction section 20 is obtained. In Step S11, the number of repetitions (i) of the integration/separation control section is initialized to 0.

In Step S20, correspondence is changed by region integration/separation. As the initial value, when the estimation results of the past image sequences have been stored, they can be used. Here, for the results of processing of the previous image or region integration/separation by the region integration/separation section 60, the process of the region correspondence section 30 is executed again. With the region integration/separation, motion parameters estimated such that image plane projection errors will be small can be used, better correspondence establishment can be achieved.

In Step S30, by using the result of change of correspondence in Step S20, the process of the region shape estimation section 40 is executed again. As a result of estimation, the depth value of each feature point in the camera coordinate system is obtained.

In Step S40, the difference between the shape estimated in Step S30 and the shape estimated by the region shape estimation section 40 previously by repetition is calculated. Specifically, the squared sum of the difference between depth values of each corresponding points in the camera coordinate system is calculated. When the accuracy of motion parameter estimation is sufficiently improved, the value of shape estimation varies little, so a value for determining whether to end the processing procedure in the next step is obtained.

In Step S50, it is determined whether the value of shape estimation error calculated in Step S40 is smaller than a set threshold value. The threshold value can be set empirically. If the variation of estimation error is small, it is unnecessary to repeat estimation, so control advances to Step S100 where control is performed to stop repetition. If the variation of error is larger than the set threshold value, it is still necessary to improve the accuracy, so control advances to Step S60.

In the process of Step S60, region rigid motion estimation is performed. Here, the region rigid motion estimation section 50 processes the result of shape estimation obtained from the process of Step S40 again. Because the region rigid motion estimation requires estimated depth values of feature points, when accurate depth values are obtained, the accuracy of rigid motion estimation is also improved.

In Step S70, the result of the rigid motion estimation in Step S60 is used to perform region integration/separation control. Specifically, the region integration/separation section 60 performs processing by using the result of the estimation of Step S60. When the accuracy of rigid motion estimation accuracy is improved, the accuracy of calculation of projection screen error is also improved, which affects the integration/separation process as a region change process.

In Step S80, the change by integration or separation is checked for the region processed in Step S70, and the processing is controlled. The change of the number of processed points is checked for each of integration and separation by using the results of the region integration/separation section 60 obtained in the last instance of repetition or in the previous image sequence. Then, a difference in the number of processed points is calculated, and if the difference is smaller than a set threshold value, the control to stop repetition of Step S100 is executed. If the number of integrated/separated points is larger than the threshold value, it is likely that separation of inliers/outliers or the like has not been performed sufficiently. Accordingly, control advances to the control of Step S90.

In Step S90, the variable (i) representing the number of repetitions is increased by one. In Step S95, it is determined whether the number of repetitions is a threshold value or greater. When integration/separation is continuously repeated, it is likely that calculation has failed in each step of estimation due to a large number of miscorrespondences in the estimation. In such a case, it is difficult to continuously execute repeat control, and therefore if the number of repetitions exceeds the set threshold value, control advances to Step S100 where the process is stopped. Otherwise, the processing procedure of Step S20 is continuously performed. The threshold value used in Step S95 can also be set empirically.

The above-described steps are basically a combination of control operations that repeatedly execute the processor that implements the units of Embodiment 1 of the present invention, and merely an example of producing better effects of the present invention. The threshold values used in Steps S50 and Step S80 may be values set empirically, or if prior knowledge is obtained for the scene, appropriate values provided in advance may be used. In Step S50, the measurement range of the obtained shape estimation may be set as a parametric threshold value. In Step S80, the number of integrations/separations may be used as a parametric threshold value.

### Other Embodiments

The present invention can be used as an image processing unit in combination with another image sensing device as in the example described in Embodiment 1, and it can also be implemented as a computer program.

The configuration according to an embodiment of the present invention can be used to detect a moving subject region and transmit only a subject region by implementing it as a computer program. In the case of using a network, when the amount of information is large such as images, by using only captured regions, the amount of information can be reduced.

In conventional subject region detection, a method in which a subject as a foreground is captured in an environment called “blue background” in which the background is colored with a uniform color is commonly used in the field of broadcasting. Although this method is commonly used in the field of broadcasting, it is rare for ordinary video camera users outside the field to make such shooting preparation because the preparation is complicated.

With the embodiments of the present invention, subject regions can be obtained dynamically even when a moving subject is captured by a moving image sensing device. An example of a preferred method of use of the present invention will be described with reference to FIG. 5.

A personal computer 530 includes hardware such as a CPU, a recording element, an external recording element and a bus that connect them, and a function in which an OS runs, and also includes a keyboard and a mouse as input units, and a liquid crystal display as an image output unit.

The image processing method of the present invention is incorporated into an application program so that the OS can use it. The application is loaded onto a recording region of the personal computer 530 and executed. The application is configured such that processing parameter modification, operational instruction and processing result verification according to the image processing method of the present invention can be displayed on a screen. A GUI 530 of the application is configured to be operated by the user through the use of the keyboard and the mouse provided in the personal computer 530.

An image sensing device 200 is connected to an external input interface of the personal computer 530 with a cable 501. Generally, an USB camera and an IEEE 1394 camera can be used. A device driver for the image sensing device has been installed in the personal computer 530, so it is ready to acquire captured images.

A cameraman 510 is holding the image sensing device 200 by hand to capture a subject. The image sensing device 200 captures the moving subject while moving in a direction indicated by an arrow 520.

As the moving subject 600, a vehicle is used. The subject 600 moves in a direction indicated by an arrow 610, and passes in front of the cameraman 510. In addition, the scene to be captured includes a stationary subject 600, and the stationary subject 600 is also included in captured images.

In order to start shooting, the application that incorporates the image processing method as an embodiment of the present invention is executed by the personal computer 530, and an instruction to start shooting is issued from the GUI 530 through the mouse or keyboard.

After the moving subject 600 has been captured, an instruction to end shooting is issued from the GUI 530 through the mouse or keyboard. The GUI 530 performs the process described in Embodiment 1 of the present invention, and presents the results from a region information output section 120 and the region shape estimation section 40 accompanied by the region information output section 120 in the form of three-dimensional graphics by using a graphics library. As the graphics library, a generic three-dimensional graphics library such as OpenGL can be used, but even when the personal computer 530 does not have such a function, images can be generated by using the CPU.

The user can view the region information of the subject 600 presented on the GUI 530 and thereafter upload information regarding the subject 600 to a network server. In this example, data can be transmitted to a server 575 located on a communication path of the Internet 570 via a wireless LAN router 560 by using a wireless LAN module 550 provided in the personal computer 530.

As the data transmission format, protocols defined by the wireless LAN or the Internet can be used without modification. When HTTP is used, data transmission can be performed easily even when a proxy is used.

Furthermore, it is also possible to add user comments for the subject 600. For example, by adding subject attributes, information regarding the captured location and information regarding the hardware used, it is possible to improve convenience for the user to check the subject later.

When the server 575 receives the region and additional information regarding the subject 600, the server 575 registers them in a web server of the server 575 such that they can be browsed. This can be accomplished by placing user comments and an HTML file containing the first frame image of the subject 600 as a snapshot in a browsable folder of the server, for example.

A user of a personal computer 580 connected to the Internet 570 can view the information provided by the server 575 through a web browser.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Patent Application No. 2009-145822, filed on Jun. 18, 2009, which is hereby incorporated by reference herein in its entirety.

What is claimed is:

1. An image processing unit comprising:
an image acquisition unit configured to receive a plurality of captured images;
a region extraction unit configured to extract a plurality of regions from each of the plurality of captured images according to an attribute of each pixel;
a region correspondence unit configured to determine corresponding regions between the plurality of captured images, according to an attribute of each of the plurality of regions extracted by the region extraction unit;
a region shape estimation unit configured to estimate a shape of the corresponding region by estimating three-dimensional positions of feature points within an image of the corresponding region;
a region rigid motion estimation unit configured to estimate rigid motion of the corresponding region by calculating motion of each feature point of the corresponding region based on the three-dimensional position thereof; and
a region change unit configured to integrate more than one regions of the plurality of regions when an accuracy of rigid motion estimated assuming that the more than one regions are integrated is determined to be higher than the rigid motion estimated for each of the more than one regions.

2. The image processing unit according to claim 1, wherein the region change unit separates one region into a plurality of regions when an accuracy of rigid motion estimated for the one of the plurality of regions falls below a prescribed level.

3. The image processing unit according to claim 2, further comprising a repeat control unit configured to repeatedly operate the region shape estimation unit, the region rigid motion estimation unit and the region change unit for the region changed by the region change unit,
wherein the repeat control unit stops the repetition when a difference between estimation results obtained by the region shape estimation unit before and after the repetition is smaller than a prescribed threshold value regarding estimation results.

4. The image processing unit according to claim 3, wherein the repeat control unit stops the repetition when a difference between the number of regions changed by the region change unit before and after the repetition is smaller than a prescribed threshold value regarding the number of regions.

5. An image processing method comprising the steps of:
receiving a plurality of captured images;
extracting a plurality of regions from each of the plurality of captured images, according to an attribute of each pixel;
determining corresponding regions between the plurality of captured images according to an attribute of each of the plurality of extracted regions;
estimating a shape of the corresponding region by estimating three-dimensional positions of feature points within an image of the corresponding region;
estimating rigid motion of the corresponding region by calculating motion of each feature point of the corresponding region based on the three-dimensional position thereof; and
integrating more than one regions of the plurality of regions when an accuracy of rigid motion estimated assuming that the more than one regions are integrated is determined to be higher than the estimated rigid motion for each of the more than one regions.

6. A computer-readable recording medium in which a computer program that causes a computer to execute the method according to claim 5 is recorded.
